(19) United States
(12) Patent Application Publication
(10) Pub. No.: US 2015/0066387 A1
(43) Pub. Date: Mar. 5, 2015

(54) SUBSTANCE IDENTIFICATION METHOD AND MASS SPECTROMETER USING THE SAME

(71) Applicant: SHIMADZU CORPORATION, Kyoto-shi (JP)

(72) Inventors: Yoshihiro YAMADA, Kyoto-shi (JP); Shigeki KAJIHARA, Uji-shi (JP)

(73) Assignee: SHIMADZU CORPORATION, Kyoto-shi (JP)

(21) Appl. No.: 14/471,907

(22) Filed: Aug. 28, 2014

(30) Foreign Application Priority Data
Aug. 30, 2013 (JP) 2013-178770

(51) Int. Cl. H01J 49/00

(52) U.S. Cl. CPC H01J 49/0027; H01J 49/004
USPC 702/23

(57) ABSTRACT

MS¹ and MS² measurements of fractionated samples are performed. Based on the identification results and the S/N ratios of the MS¹ peaks, an identification probability estimation model showing a relationship between the cumulative number of MS¹ peaks and the number of MS¹ peaks successfully identified through the MS² measurements and identifications performed in ascending order of S/N ratio is created. S/N ratios of the MS¹ peaks obtained by MS¹ measurements are determined, and probabilities of substances in a target sample are estimated from S/N ratios using the aforementioned model. Optimization of precursor-ion selection and data-accumulation number is defined as the problem of maximizing the sum of identification probabilities of MS¹ peaks selected for MS² measurement, and formulated as an objective function using 0-1 variables. This function is solved as a 0-1 integer programming problem under preset conditions. Optimal precursor ions and data-accumulation numbers are determined from variables of the solution.

### TECHNICAL FIELD

The present invention relates to a method for identifying a substance or substances contained in a sample by using a mass spectrometer capable of an MSⁿ measurement (where n is an integer equal to or greater than two), and a mass spectrometer for identifying a substance or substances contained in a sample by using the same method.

### BACKGROUND ART

In bioscience research, medical treatment, drug development and similar fields, it has become increasingly important to examine biological samples to comprehensively identify various substances, such as proteins, peptides, nucleic acids and sugar chains. In particular, when aimed at proteins or peptides, such a comprehensive analysis method is called “shotgun proteomics.” For such analyses, the combination of a chromatographic technique, such as a liquid chromatograph (LC) or capillary electrophoresis (CE), with an MSⁿ mass spectrometer (tandem mass spectrometer) has proven itself to be a very powerful technique.

A procedure of a commonly known method for comprehensively identifying various kinds of substances in a biological sample by means of an MSⁿ mass spectrometer is as follows:

[Step 1] Various substances contained in a sample to be analyzed are separated by an appropriate method, e.g. LC or CE. The thereby obtained eluate is preparative-fractionated to prepare a number of small amount samples. (Each of the small amount samples obtained by preparative fractionation is hereinafter called the “fractionated sample.”) The preparative fractionation of a sample should be performed in such a manner that small amount samples are collected either continuously at regular predetermined intervals of time or constantly in the same amount so that every substance in the sample will be successfully included in one of the fractionated samples.

[Step 2] For each fractionated sample, an MS¹ measurement is performed to obtain an MS¹ spectrum, and a peak or peaks that are likely to have originated from a substance or substances to be identified are selected on the MS¹ spectrum.

[Step 3] Using a peak selected in Step 2 as the precursor ion, an MS² measurement for the fractionated sample concerned is performed. Then, based on the result of this measurement, a database search or de novo sequencing is performed to identify a substance or substances contained in the fractionated sample.

[Step 4] If no specific substance has been identified with sufficient accuracy, an MS² measurement using another peak on the MS¹ spectrum as the precursor ion is performed, or a higher-order MSⁿ measurement (i.e. n=3 or greater) using a specific ion observed on the MS² spectrum as the precursor ion is performed. Then, a database search, de novo sequencing or similar data processing based on the result of the measurement is performed to identify a substance or substances contained in the fractionated sample.

[Step 5] The processes of Steps 2 through 4 are performed for each of the fractionated samples to comprehensively identify various substances contained in the original sample.

To identify each of the substances with high accuracy by the previously described comprehensive identification process, it is desirable that each fractionated sample should contain a small number of kinds of substances (most desirably, only one kind). To achieve this, it is necessary to shorten the period of each fractionating cycle, which significantly increases the number of cycles of fractionation. Considering that, to identify as many substances as possible within a limited length of measurement time or with a limited number of times of the measurement, i.e. to improve the throughput of the comprehensive identification of one or more substances contained in a fractionated sample, it is necessary to preferentially select, as the precursor ion, one or more peaks having a higher probability of successful identification (which is hereinafter called the “identification probability”) among the peaks observed on the MS¹ spectrum and perform the MSⁿ analysis under appropriate measurement conditions.

One conventional method for selecting a precursor ion for an MS² measurement from the peaks observed on an MS¹ spectrum obtained for a given sample is to sequentially select the peaks on the spectrum in descending order of intensity (see Patent Literature 1). For example, if the length of time or the number of times for the MS² measurement of one sample is limited, the system is controlled so that a predetermined number of peaks will be sequentially selected as the precursor ion in descending order of their intensities. In another commonly known method, all the peaks, without limiting the number of peaks, whose intensities are equal to or greater than a predetermined threshold are selected as precursor ions, provided that the measurement can be performed for an adequate length of time or an adequate number of times.

These methods seem to entirely rely on the assumption that using an ion having a higher peak intensity ensures a higher identification probability. Although this assumption is not qualitatively wrong, it should be noted that the peak intensity does not always correspond to the value of identification probability. For example, suppose that there are multiple peaks that can be chosen as a precursor ion. In some cases, choosing any one of these peaks will result in successful identification with high probability, while in other cases successful identification can be expected only when a specific peak among them is chosen. Quantitatively discriminating between such different situations from the peak intensity beforehand is considerably difficult.

To address this problem, the applicant has proposed a novel technique described in Patent Literature 2, which includes the steps of quantitatively estimating the probability of substance identification using an MS² measurement result before the MS² measurement is actually performed, evaluating variously estimated probabilities, and selecting an MS² precursor ion and measurement conditions so as to maximize the expected value of the number of substances that will be identified. With this method, it is possible to find a peak which is highly likely to lead to a successful identification and hence more appropriate as the precursor ion, or to sequentially select a plurality of peaks as the precursor ion in a more appropriate order, based on a result of a quantitative evaluation.

### CITATION LIST

### Patent Literature

Patent Literature 1: JP 3766391 B

Patent Literature 2: JP 2013-101039 A

### SUMMARY OF INVENTION

### Technical Problem

In a preparative fractionation of sample components separated by LC or GC, it is often the case that one component is contained in the sample over a plurality of successive fractionations. In particular, in the case of a temporal fractionation in which a sample liquid eluted from a column is fractionated at regular intervals of time, the same component may be contained at close concentrations in two or more fractionated samples. In such a case, it is necessary to determine which of those fractionated samples is appropriate for the identification of that component.

In a mass spectrometer using a matrix assisted laser desorption/ionization (MALDI) ion source, since the amount of ions generated from a sample component by each laser irradiation considerably varies, the same measurement is performed multiple times for one sample and a spectrum to be used for identification is calculated by accumulating the results of the multiple measurements. Increasing the number of repetitions of the measurement (i.e. the number of data accumulations) improves the identification accuracy but requires an accordingly longer period of time. Therefore, for an identification of a given component, it is preferable to optimize not only the selection of MS² precursor ions but also the number of data accumulations.

In the conventional technique described in Patent Literature 2, neither the optimal selection of the fractionated sample nor the optimization of the number of data accumulations is taken into account. Therefore, no optimal selections can be made in those respects.

The present invention has been developed to solve such problems, and its objective is to provide a substance identification method and a mass spectrometer using the method in which a large number of substances contained in a sample can be identified with high reliability based on mass spectrometric data obtained with high efficiency, i.e. with the smallest possible number of times of the measurement or the shortest possible measurement time, while optimizing not only the selection of precursor ions but also the number of data accumulations and the selection of a fractionated sample.

### Solution to Problem

The substance identification method according to the first aspect of the present invention aimed at solving the previously described problem is a substance identification method for identifying a substance contained in each of a plurality of fractionated samples obtained by separating various substances contained in a sample according to a predetermined separation parameter and fractionating the sample, based on MSⁿ spectra obtained by performing an MSⁿ measurement (where n is an integer equal to or greater than two) for each of the plurality of fractionated samples, the method including:

a) an identification probability estimation model creation step, in which an identification probability estimation model is created using signal-to-noise ratios (S/N ratios) of MSⁿ⁻¹ peaks determined by MSⁿ⁻¹ measurements for a plurality of fractionated samples obtained from a predetermined sample and the results of substance identification based on the results of MSⁿ measurements performed using each of the MSⁿ⁻¹ peaks as a precursor ion, the identification probability estimation model showing a relationship between the signal-to-noise ratios of a plurality of MSⁿ⁻¹ peaks originating from the same kind of sample and the cumulative number of peaks successfully identified through a series of MSⁿ measurements and identifications in which the MSⁿ⁻¹ peaks are sequentially selected as a precursor ion in order of signal-to-noise ratio, and in which identification probability estimation model information representing the identification probability estimation model is stored;

b) an identification probability estimation step, in which, after MSⁿ⁻¹ measurements for two or more fractionated samples successively obtained from a target sample to be identified are completed, a signal-to-noise ratio is calculated for each of a plurality of MSⁿ⁻¹ peaks which are candidates of the precursor ions for the MSⁿ measurements among the MSⁿ⁻¹ peaks found by the MSⁿ⁻¹ measurements, and in which an estimate of the identification probability of each of the MSⁿ⁻¹ peaks which are the candidates of the precursor ions is calculated from the signal-to-noise ratios of the MSⁿ⁻¹ peaks with reference to the identification probability estimation model created from the identification probability estimation model information; and

c) a measurement condition optimization step, in which, after an assumption is made about how much an identification probability will be improved by performing an MSⁿ measurement for the same MSⁿ⁻¹ peak a plurality of times and accumulating the results of the plurality of measurements, an objective function which maximizes the sum of the identification probabilities for various combinations of MSⁿ⁻¹ peaks and various number of data accumulations ranging from one to a preset number is formulated based on the identification probabilities respectively estimated in the identification probability estimation step for all the MSⁿ⁻¹ peaks which are precursor-ion candidates for a predetermined set of fractionated samples, and in which MSⁿ⁻¹ peaks to be subjected to the MSⁿ measurement are selected and the number of data accumulations for each of the selected MSⁿ⁻¹ peaks is determined by finding a solution which maximizes the objective function with constraint conditions imposed at least on the total number of executions of the MSⁿ measurement for the predetermined set of fractionated samples and on the total number of executions of the MSⁿ measurement for one fractionated sample.

The substance identification method according to the second aspect of the present invention aimed at solving the previously described problem is a substance identification method for identifying a substance contained in each of a plurality of fractionated samples obtained by separating various substances contained in a sample according to a predetermined separation parameter and fractionating the sample, based on MSⁿ spectra obtained by performing an MSⁿ measurement (where n is an integer equal to or greater than two) for each of the plurality of fractionated samples, the method including:

a) an identification probability estimation model creation step, in which an identification probability estimation model is created using signal-to-noise ratios of MSⁿ⁻¹ peaks determined by MSⁿ⁻¹ measurements for a plurality of fractionated samples obtained from a predetermined sample and the results of substance identification based on the results of MSⁿ measurements performed using each of the MSⁿ⁻¹ peaks as a precursor ion, the identification probability estimation model showing a relationship between the signal-to-noise ratios of a plurality of MSⁿ⁻¹ peaks originating from the same kind of sample and the cumulative number of peaks successfully identified through a series of MSⁿ measurements and identifications in which the MSⁿ⁻¹ peaks are sequentially selected as a precursor ion in order of signal-to-noise ratio, and in which identification probability estimation model information representing the identification probability estimation model is stored, where

the identification probability estimation model for each number of data accumulations is created using the results of substance identification obtained by performing an MSⁿ measurement for the same MSⁿ⁻¹ peak a plurality of times and accumulating the results of the measurements while changing the number of times of the measurement, and identification probability estimation model information representing each of the identification probability estimation model is stored;

b) an identification probability estimation step, in which, after MSⁿ⁻¹ measurements for two or more fractionated samples successively obtained from a target sample to be identified are completed, a signal-to-noise ratio is calculated for each of a plurality of MSⁿ⁻¹ peaks which are candidates of the precursor ions for the MSⁿ measurements among the MSⁿ⁻¹ peaks found by the MSⁿ⁻¹ measurements, and in which an estimate of the identification probability of each of the MSⁿ⁻¹ peaks which are the candidates of the precursor ions is calculated for each number of data accumulations from the signal-to-noise ratios of the MSⁿ⁻¹ peaks with reference to the identification probability estimation model created from the identification probability estimation model information; and

c) a measurement condition optimization step, in which an objective function which maximizes the sum of the identification probabilities for various combinations of MSⁿ⁻¹ peaks and various number of data accumulations ranging from one to a preset number is formulated based on the identification probabilities respectively estimated in the identification probability estimation step for all the MSⁿ⁻¹ peaks which are precursor-ion candidates for a predetermined set of fractionated samples, and in which MSⁿ⁻¹ peaks to be subjected to the MSⁿ measurement are selected and the number of data accumulations for each of the selected MSⁿ⁻¹ peaks is determined by finding a solution which maximizes the objective function with constraint conditions imposed at least on the total number of executions of the MSⁿ measurement for the predetermined set of fractionated samples and on the total number of executions of the MSⁿ measurement for one fractionated sample.

In the present invention, the separation of various kinds of substances contained in a sample can be achieved by a liquid chromatograph (LC), capillary electrophoresis (CE) or any other means. In the case of the LC or similar device using a column, the aforementioned separation parameter is time (retention time). That is to say, one fractionated sample contains one or more substances eluted from the column within a predetermined range of time. In the case of using CE to separate various kinds of substances contained in a sample, the separation parameter is mobility.

There is no limitation on the method for identifying a substance or substances based on an MSⁿ spectrum. For example, de novo sequencing, MS/MS ion search or any algorithm can be used. It should be noted that the same algorithm must be used both in the identification process performed in the identification probability estimation model creation step (or by the identification probability estimation model creator) and in the identification process performed on a sample of interest obtained from a target sample.

In the identification probability estimation model creation step of the substance identification method according to the first aspect of the present invention, the identification probability estimation model information is determined by using data in which the MSⁿ⁻¹ measurements, the MSⁿ measurements and the results of identification performed by using the outcome of the MSⁿ measurements (i.e. whether or not the identification was successful) are completely obtained. The identification probability estimation model shows a relationship between the signal-to-noise ratios of a plurality of MSⁿ⁻¹ peaks (normally, a considerable number of peaks) and the cumulative number of peaks which will be successfully identified through a series of MSⁿ measurements and identifications with each of the MSⁿ⁻¹ peaks sequentially selected as a precursor ion in ascending or descending order of their signal-to-noise ratios. Accordingly, this identification probability estimation model indicates what proportion of MSⁿ⁻¹ peaks having signal-to-noise ratios higher or lower than that of an MSⁿ⁻¹ peak exhibiting a certain signal-to-noise ratio are expected to be successfully identified among all the MSⁿ⁻¹ peaks. A signal-to-noise ratio of an MS¹ peak can be computed from the signal intensity of this MS¹ peak and the noise level calculated from the MS¹ spectrum (with a profile before undergoing a noise removal or other processing) which contains the same peak.

Specifically, the relationship between the cumulative number of MSⁿ⁻¹ peaks sequentially selected in ascending or descending order of signal-to-noise ratio and the total number of successfully identified MSⁿ⁻¹ peaks will be shaped like a line which increases in a staircase pattern. Accordingly, in the identification probability estimation model creation step, for example, a fitting for determining a continuous relationship between the cumulative number of MSⁿ peaks and the number of successful identifications may be performed to obtain a smooth fitting curve, and a function formula representing the shape of the curve or one or more coefficients and/or constants included in the function formula may be used as the identification probability estimation model information.

In the identification probability estimation model creation step of the substance identification method according to the first aspect of the present invention, the identification probability estimation model information is obtained only for such a case where the MSⁿ measurement is performed one time for each MSⁿ⁻¹ peak, i.e. without taking into account the number of data accumulations (or the number of data accumulations is one). By contrast, in the substance identification method according to the second aspect of the present invention, the identification probability estimation model information is obtained for each of a plurality of numbers of data accumulations ranging from one to a preset value, i.e. taking into account the number of times of the MSⁿ measurement to be performed for the same MSⁿ⁻¹ peak so as to accumulate the measured results. In the first aspect of the present invention, the identification probability for the case where the number of data accumulations is not one needs to be deduced from the identification probability for the case where the number of data accumulation is one. In the second aspect of the present invention, such a deduction is unnecessary and the identification probability for any number of data accumulations can be directly obtained from the identification probability estimation model information.

An appropriate identification probability estimation model depends on the kind of sample, or more exactly, on the kinds of substances contained in the sample. In other words, the same identification probability estimation model information can be used in the case of identifying the same kind or a similar kind of substance. For example, when the measurement is aimed at identifying proteins in a biological sample, the identification probability estimation model information can be previously prepared on the basis of MSⁿ⁻¹ peaks or other data obtained for a preparatory sample containing various kinds of previously identified proteins.

For example, suppose the case where an MSⁿ⁻¹ measurement is performed for a plurality of fractionated samples obtained from a sample containing unknown substances and the selection of MSⁿ⁻¹ peaks to be used in the subsequent MSⁿ measurement is determined from the result of the MSⁿ⁻¹ measurement. In this case, in the identification probability estimation step, an S/N ratio is initially calculated for each of a plurality of MSⁿ⁻¹ peaks observed on the MSⁿ⁻¹ spectra obtained from the fractionated samples. The S/N ratio should be calculated by the same method as used in the process of creating the identification probability estimation model. Then, with reference to the identification probability estimation model created from the identification probability estimation model information, an estimate of the identification probability is calculated from each of the S/N ratios of the MSⁿ⁻¹ peaks. Thus, the probability of successful identification based on the result of an MSⁿ measurement for a given MSⁿ⁻¹ peak can be quantitatively estimated before the MSⁿ measurement is actually performed.

Subsequently, in the measurement condition optimization step, the selection of the precursor ions to be subjected to the MSⁿ measurement is optimized and the number of data accumulations is determined so that the largest possible number of substances will be identified. As already explained, it is possible that MSⁿ⁻¹ peaks originating from the same component emerge over MSⁿ⁻¹ spectra obtained from a plurality of successively fractionated samples. Accordingly, the optimization of the selection of precursor ions to be subjected to the MSⁿ measurement does not only mean optimizing the selection of an MSⁿ⁻¹ peak in one fractionated sample; if there is an MSⁿ⁻¹ peak spread over a plurality of fractionated samples, the optimization also means optimizing the selection of the MSⁿ⁻¹ peak from the entire group of those fractionated samples.

In the measurement condition optimization step of the first aspect of the present invention, initially, an assumption is made about how much the identification probability improves for an increase in the number of data accumulations on the same MSⁿ⁻¹ peak. As one example, it may be assumed that the identification probability achieved by increasing the number of data accumulations m-fold is equal to an identification probability at a √m-fold S/N ratio. On the other hand, in the second aspect of the present invention, it is unnecessary to make an assumption as in the first aspect of the present invention, since the identification probability estimation model information is prepared for each number of data accumulations.

In any cases, in the measurement condition optimization step, an objective function which maximizes the sum of identification probabilities for various combinations of MSⁿ⁻¹ peaks and various data-accumulation numbers ranging from one to a preset number is formulated based on the identification probabilities respectively estimated in the identification probability estimation step for all the MSⁿ⁻¹ peaks which are precursor-ion candidates for a predetermined set of fractionated samples. Furthermore, constraint conditions are imposed at least on the total number of executions of the MSⁿ measurement for the predetermined set of fractionated samples and on the total number of executions of the MSⁿ measurement for one fractionated sample. Other constraint conditions may also be added, such as the condition that MSⁿ⁻¹ peaks originating from the same component should be selected from only one of the fractionated sample. Then, MSⁿ⁻¹ peaks to be used as precursor ions for the MSⁿ measurement are selected and the number of data accumulations for each of the selected MSⁿ⁻¹ peaks is determined by finding a solution which maximizes the objective function under those constraint conditions.

Thus, with the substance identification methods according to the first and second aspects of the present invention, the selection of precursor ions and the determination of the number of executions of the MSⁿ measurement can be appropriately performed previously, i.e. before the MSⁿ measurement is actually performed, using quantitative values of the identification probability calculated based on an identification probability estimation model, so that the largest possible number of substances will be identified.

When there is only a limited amount of sample for the measurement, it is necessary to take into account the decrease in the amount of sample due to the consumption of the sample in each measurement. Normally, a peak with a low S/N ratio is more easily affected by a depletion of the sample. Accordingly, for example, after the MSⁿ⁻¹ peaks to be subjected to the MSⁿ measurement are selected in the previously described manner, it is preferable to give a higher level of priority to an MSⁿ⁻¹ peak with a lower S/N ratio in performing the MSⁿ measurement. By this method, it is possible to minimize the effect of the depletion of the sample and identify a large number of substances.

In a preferable mode of the substance identification method according to the present invention, the measurement condition optimization step is performed in such a manner that the objective function and the constraint conditions are formulated as a linear programming problem, and a solution which maximizes the objective function is found. More specifically, the objective function and the constraint conditions can be formulated as a 0-1 integer programming problem (which is one type of the linear programming problem) in which each MS¹ peak with a 0-1 variable of 1 and the number of data accumulations for this peak are found as the solution which maximizes the objective function. The linear programming problem may be solved by any method; there are the various conventionally proposed methods available for this purpose.

In a preferable mode of the substance identification method according to the present invention, a measurement for the predetermined sample is performed before the measurement for the target sample, and based on a result of the former measurement, the identification probability estimation model is created in the identification probability estimation model creation step. If the measurement for a predetermined sample prepared for the creation of the identification probability estimation model is performed immediately before the measurement for the target sample, the measurement conditions can be substantially equalized; e.g. the noise environment will be almost the same. This improves the application accuracy of the identification probability estimation model created for the predetermined sample, and thereby improves the accuracy of the estimate of the identification probability, so that the order of priority can be more accurately determined.

In the substance identification method according to the present invention, it is preferable to determine a measurement sequence of the MSⁿ measurement based on a result of a sequential process in the identification probability estimation step and the measurement condition optimization step before the MSⁿ measurement is actually performed. In this case, the control of the MSⁿ measurement becomes simple since the MSⁿ measurement using each of the MSⁿ⁻¹ peaks as the precursor ion can be performed by simply following a measurement sequence which is determined at the beginning.

In one mode of the substance identification method according to the present invention, a measurement sequence of the MSⁿ measurement is determined based on a result of a sequential process in the identification probability estimation step and the measurement condition optimization step before the MSⁿ measurement is actually performed, and after the MSⁿ measurement according to the measurement sequence is initiated, the measurement sequence is modified by using an identification result obtained in the course of the MSⁿ measurement.

For example, while the MSⁿ measurement is being performed sequentially for different MSⁿ⁻¹ peaks or repeatedly for the same MSⁿ⁻¹ peak according to a measurement sequence, if the situation where no substance can be identified from the result of the MSⁿ measurement has continued, the MSⁿ measurement according to that measurement sequence may be discontinued at that point in time so as to move to the MSⁿ measurement and identification for the next fractionated sample. This is effective for reducing the number of meaningless executions of the MSⁿ measurement and avoiding a decrease in the identification probability in the case where a certain discrepancy exists between the identification probability estimation model and the actual result of identification.

The mass spectrometer according to the present invention is a mass spectrometer capable of an MSⁿ measurement which performs substance identification using any of the substance identification methods according to the present invention. The mass spectrometer is characterized by a controller for carrying out an MSⁿ measurement with the precursor ion and the number of data accumulations automatically set according to an MSⁿ measurement sequence based on a result obtained in the measurement condition optimization step. The mass spectrometer may be any type of mass spectrometer as long as it is capable of selecting an ion having a specific mass-to-charge ratio and dissociating the selected ion.

The mass spectrometer according to the present invention can automatically perform an MSⁿ measurement with the precursor ion and the number of data accumulations selected or determined by the substance identification method in the previously described manner before the MSⁿ measurement is actually performed. Analysis operators do not need to manually enter MSⁿ measurement conditions or other information. Thus, the time and labor of the analysis operators is reduced and the task of identifying a target sample can be efficiently performed.

### Advantageous Effects of the Invention

With the substance identification method according to the present invention, it is possible to select MSⁿ⁻¹ peaks as precursor ions from one fractionated sample, to select one of the MSⁿ⁻¹ peaks originating from the same substance and spread over a plurality of fractionated samples as a precursor ion, and to determine an optimal number of times of the MSⁿ measurement for each MSⁿ⁻¹ peak so that the largest possible number of substance will be identified, before an MSⁿ measurement for identifying a number of unknown substances contained in a target sample is actually performed. As a result, for example, the measurement time or the number of times of the measurement required for successfully identifying as many substances as in the conventional case will be reduced. This also means that a larger number of substance can be successfully identified if the same measurement time or the same number of times of the measurement as in the conventional case is given.

### BRIEF DESCRIPTION OF DRAWINGS

FIG. 1 is a block diagram schematically showing the configuration of a mass spectrometer which performs the substance identification method according to the present invention.

FIG. 2 is a flowchart showing a process of creating an identification probability estimation model in the substance identification method according to the present invention.

FIG. 3 is a flowchart showing a process of optimizing an MS² measurement sequence based on an identification probability estimation model in the substance identification method according to the present invention.

FIG. 4 shows an example of an MS¹ profile (mass spectrum) for explaining a noise-level evaluation process.

FIG. 5 shows an example of the result of a noise-level calculation for two MS¹ profiles.

FIG. 6 shows an example of the distribution of MS¹ peaks with respect to the mass-to-charge ratio m/z and the signal-to-noise ratio.

FIG. 7 is a model diagram showing the concept of an empirical cumulative distribution function of successfully identified MS¹ peaks in the case where the MS¹ peaks are ranked in order of signal-to-noise ratio.

FIG. 8 shows an empirical cumulative distribution function of successfully identified MS¹ peaks, a fitting function for that distribution function, and a change in the estimate of the identification probability based on that fitting function.

FIGS. 9A and 9B show one example of the heat-map representation of an MS¹ spectrum.

FIG. 10 shows one example of the relationship between the estimate of the identification probability and the signal-to-noise ratio in the case where data accumulation is performed a normal number of times.

### DESCRIPTION OF EMBODIMENTS

One embodiment of the substance identification method according to the present invention, and one embodiment of the mass spectrometer which performs substance identification by the same method, are hereinafter described in detail, with reference to the attached drawings.

The substance identification method according to the present invention is applied in a mass spectrometer (or compound identification system) in which, for each of a number of fractionated samples successively obtained by being separated and fractionated from a target sample by a liquid chromatograph or similar device, an MSⁿ⁻¹ measurement is performed to obtain an MSⁿ⁻¹ spectrum, one or more MSⁿ⁻¹ peaks are selected as precursor ions, an MSⁿ measurement is performed for each precursor ion to obtain an MSⁿ spectrum, and various kinds of substances contained in the target sample are identified by using the MSⁿ spectrum.

The method is characterized by the process of quantitatively estimating the probability of successful identification of a substance for an MSⁿ⁻¹ peak on an MSⁿ⁻¹ spectrum and performing an optimization of the MSⁿ measurement sequence based on the estimated probability before the MSⁿ measurement is actually performed, where the optimization includes an optimization of the selection of a precursor ion for the MSⁿ measurement, an optimization of the number of times of the MSⁿ measurement (the number of data accumulations) for precursor ions originating from the same component, and an optimization of the selection of one of the MSⁿ⁻¹ peaks originating from the same component and spread over a plurality of fractionated samples.

A method of optimizing an MSⁿ measurement sequence according to the present invention is described, taking into account one concrete example.

In the method according to the present example, an identification probability estimation model is created preliminarily, i.e. in advance of the actual measurement and identification of a target sample to be identified, by using the results of measurements and identifications performed for a sample containing a number of substances for creating an identification probability estimation model (such a sample is hereinafter simply called the “sample for model creation”). The identification probability estimation model serves as reference data for estimating the probability that an MS² measurement and identification using an MS¹ peak as a precursor ion will be successful, before actually performing the MS² measurement and identification. The sample for model creation should preferably be of the same kind as the target sample; for example, if the target sample is a peptide mixture, the sample for model creation should also be a peptide mixture.

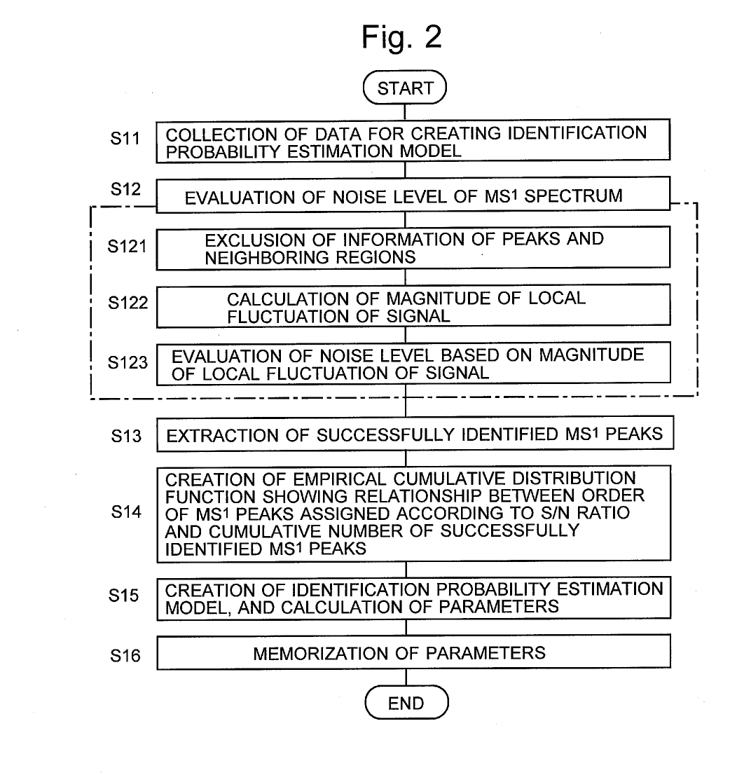

FIG. 2 is a flowchart showing the procedure of creating an identification probability estimation model. With reference to this figure, the procedure of creating an identification probability estimation model is described in detail.

[Step S11] Collection of Data for Creating Identification Probability Estimation Model

A sample for model creation is temporally separated by a liquid chromatograph, and the eluate is repeatedly collected at predetermined intervals of time to prepare a number of fractionated samples. An MS¹ measurement is performed for each fractionated sample to collect MS¹ spectrum data. For each MS¹ peak extracted from the MS¹ spectrum data, an MS² measurement, which includes one dissociating operation, is performed to collect MS² spectrum data, and an identification process using the MS² spectrum data is attempted.

In the case of identifying substances contained in each of the fractionated samples separately collected according to their retention time in the previously described manner, a three-dimensional MS¹ spectrum is created by aligning MS¹ spectra of the fractionated samples in order of their retention time. For this three-dimensional MS¹ spectrum, peak detection is performed on the two-dimensional plane of mass-to-charge ratio m/z and retention time, to extract an MS¹ peak (the 2D peak, which will be described later). Then, using the mass-to-charge ratio of this MS¹ peak as a precursor ion, an MS² measurement is performed to obtain an MS² spectrum. Based on this MS² spectrum, an identification of substances is attempted by a predetermined identification algorithm (such as de novo sequencing or MS/MS ion search). This identification process is performed for each MS¹ peak. Whether the attempt of identification has resulted in success or failure (no substances identifiable) is determined for each MS¹ peak extracted from the three-dimensional MS¹ spectrum.

[Step S12] Evaluation of Noise Level of MS¹ Spectrum

The identification probability, which will be described later, is affected by the noise level of the MS¹ spectrum. To deal with this problem, the noise level of the MS¹ spectrums obtained from the sample for model creation is evaluated. In the present example, the noise level is evaluated for each fractionated sample, i.e. for each MS¹ spectrum, by the following Steps S121-S123, based on an MS¹ raw profile (which is hereinafter simply called the “raw profile”) created from raw (unprocessed) data obtained by an MS¹ measurement. In the following description, the signal intensity of a discretized raw profile is denoted by Rₘ, where m=0, 1, . . . is a number indicating the order of mass-to-charge ratios of the sampling points on the raw profile of a sample to be evaluated. The entire set of the sampling points included in a raw profile is denoted by M.

[Step S121] Exclusion of Information of Peaks and Neighboring Regions

Let P^{(max)} denote the maximum peak intensity of the raw profile. That is to say, P^{(max)} is defined as follows:

P^{(max)}=maxRₘ (1).

(mεM)

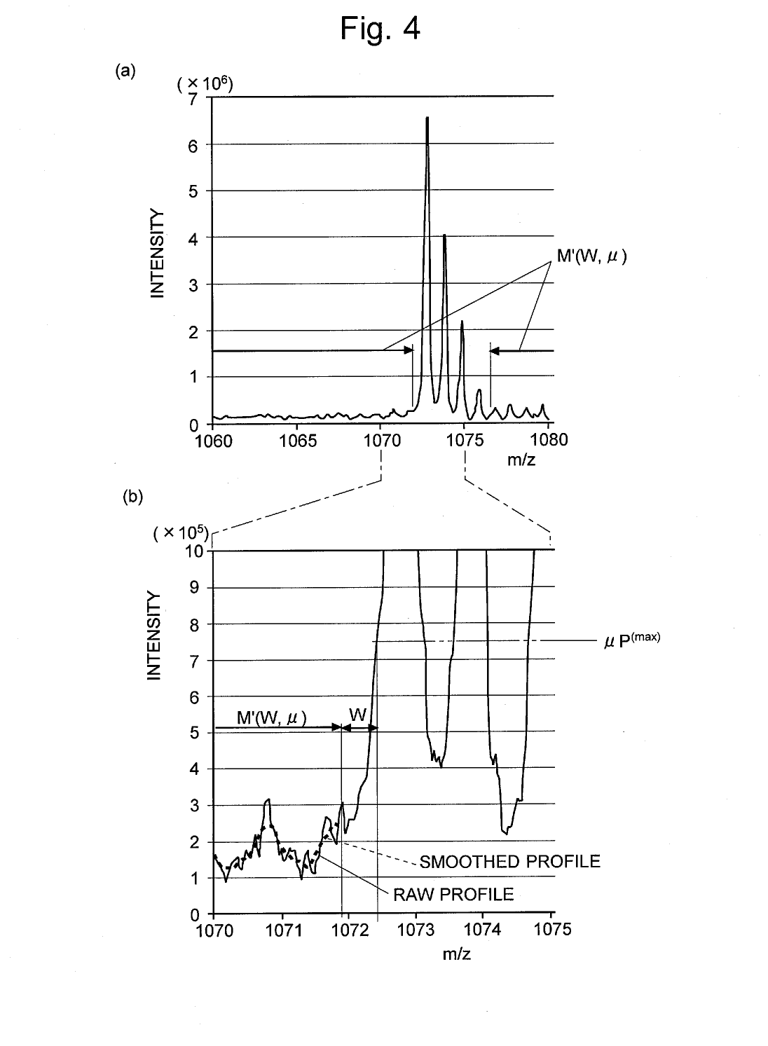

With an appropriately selected threshold μ for determining the neighboring region of a peak (0<μ<1), any sampling points having signal intensities equal to or greater than μ times the P^{(max)} are regarded as the peak portion. A set of sampling points M′(W, μ) which corresponds to the entire group of the sampling points exclusive of those included in the peak portion (i.e. exclusive of any sampling point whose distance from the nearest sampling point having an intensity of μ·P^{(max)} or greater is equal to or smaller than W) is determined. For example, graph (a) in FIG. 4 shows a set of sampling points M′(W, μ) determined in a raw profile of an MS¹ spectrum within a range from m/z 1060 to m/z 1080, and graph (b) in FIG. 4 is an enlargement of a portion of graph (a), showing a range from m/z 1070 to m/z 1075.

[Step S122] Calculation of Magnitude of Local Fluctuation of Signal

In the set of sampling points M′(W, μ) exclusive of the peaks and neighboring regions, the raw profile is smoothed by a filter with a pass band of half width W, to obtain a smoothed profile *Rₘ(W, μ). That is to say, *Rₘ(W, μ) is given by the following equation:

*Rₘ(W,μ),{1/(2W+1)}ΣR_{m′} (2).

(m′εM′(W,μ))

In equation (2), Σ is the sum of R_{m′} from m′=−W to m′=W. The difference between this smoothed profile *Rₘ(W,μ) and the original raw profile is defined as the magnitude of the local fluctuation of the signal, which is hereinafter expressed as ΔRₘ(W,μ). That is to say, ΔRₘ(W, μ) is given by the following equation:

ΔRₘ(W,μ)=Rₘ−*Rₘ(W,μ) (3).

[Step S123] Calculation of Noise Level Based on Magnitude of Local Fluctuation of Signal

In this example, the noise level N(Rₘ; W, μ) is defined as the root mean square of the magnitude of the local fluctuation of the signal ΔRₘ(W, μ) multiplied by c, where c is an appropriate constant for defining the noise level. That is to say, N(Rₘ; W, μ) is defined by the following equation:

N(Rₘ;W,μ)=c×\sqrt{ΣΔRₘ(W,μ)²} (4).

It should be noted that the definition of the noise level is not limited to this example; any form of definition is allowed as long as it appropriately represents the noise level of MS¹ spectra.

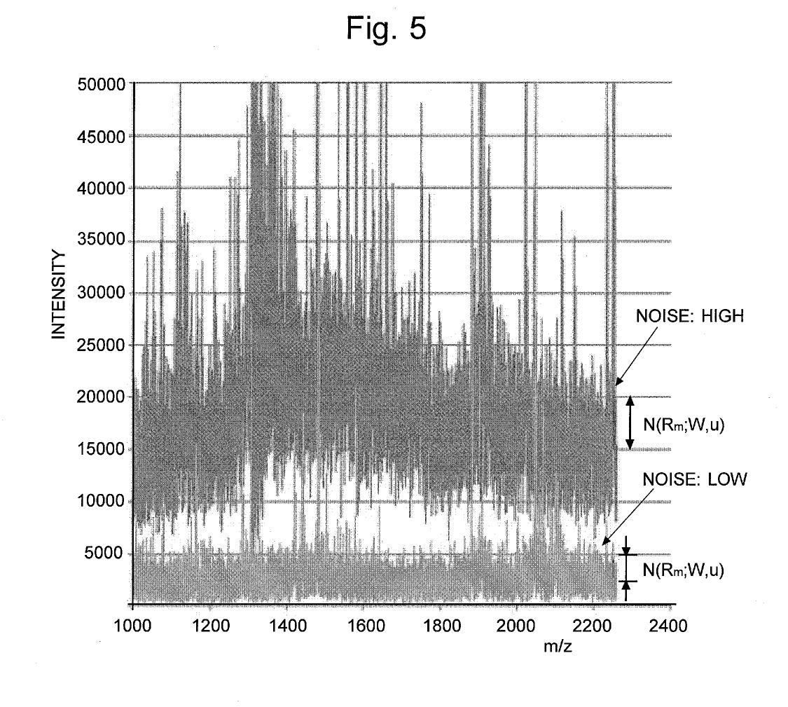

FIG. 5 shows the result of one example in which the noise level N(Rₘ; W, μ) was calculated in the previously described manner based on two actually obtained MS¹ raw profiles.

[Step S13] Extraction of Successfully Identified MS¹ Peaks

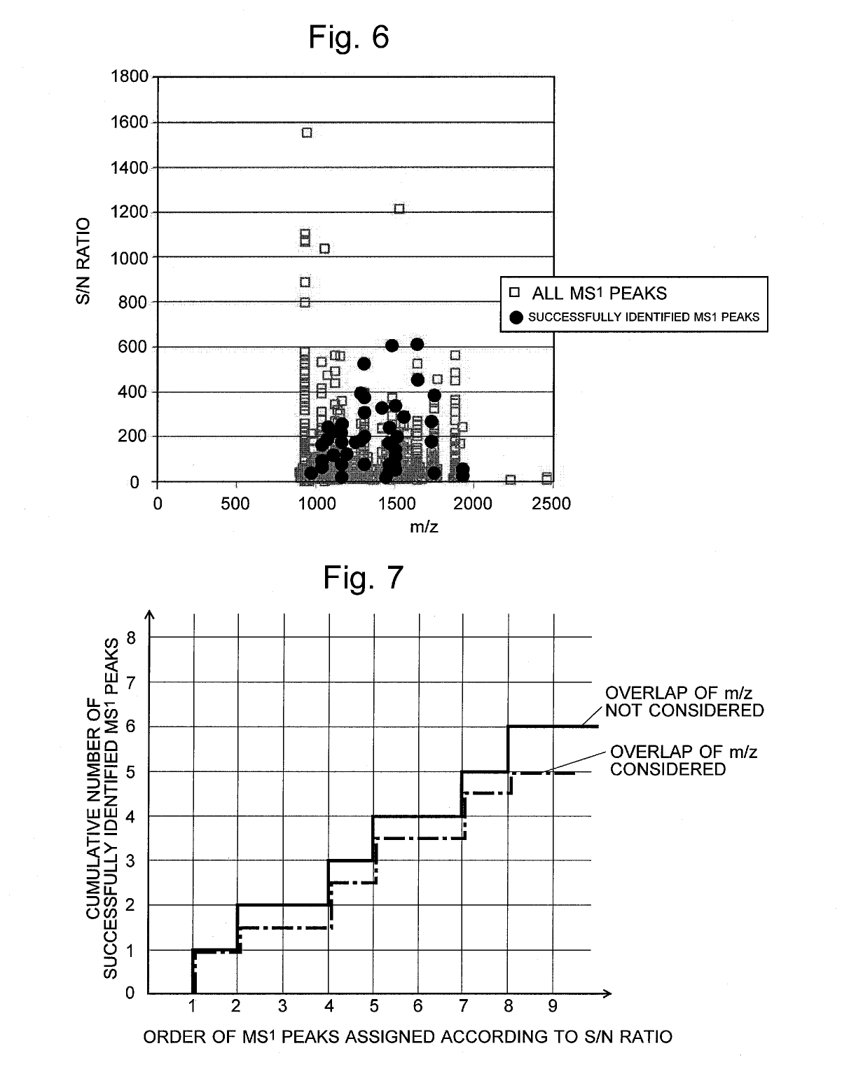

FIG. 6 is an example of a chart on which all the MS¹ peaks originating from a sample for model creation are plotted with respect to the mass-to-charge ratio m/z and the signal-to-noise (S/N) ratio. The S/N ratio in this chart is the ratio of the peak intensity to the noise level calculated in Step S12. Each of the square marks in FIG. 6 represents one MS¹ peak, while each of the circular marks indicates that a substance could be identified by an MS² measurement using that MS¹ peak as the precursor ion, i.e. that the MS¹ peak has been successfully identified. FIG. 6 demonstrates that, in the present example, the higher the S/N ratio is, the higher the proportion of successfully identified MS¹ peaks will be. This tendency is a general one and not specific to the present example.

[Step S14] Determination of Relationship Between S/N Ratio of MS¹ Peaks and Cumulative Number of Successfully Identified MS¹ Peaks

If the MS¹ peaks are extracted in descending order of S/N ratio and ranked from the 1^{st} place (i.e. if the MS¹ peaks are sorted and ranked in descending order of S/N ratio), and if the cumulative number of MS¹ peaks successfully identified until the process reaches each order is counted, a graph showing the cumulative number increasing rightward in a staircase pattern can be drawn, as shown in FIG. 7. For example, the staircase-like polygonal line drawn in the solid line in FIG. 7 shows that the MS¹ peak whose S/N ratio was ranked first was successfully identified, while the identification was unsuccessful for the MS¹ peak whose S/N ratio was ranked third and hence lower than that of the first-ranked peak. This polygonal line is an empirical cumulative distribution function which demonstrates how many of the MS¹ peaks with S/N ratios equal to or higher than a certain level have been successfully identified.

As can be seen in FIG. 6, in the present example, a plurality of MS¹ peaks which correspond to the same mass-to-charge ratio (but whose S/N ratios are not always the same) are individually identified. Accordingly, if a number of peaks are overlapped at a specific mass-to-ratio, the relative influence of that mass-to-charge ratio on the result of identification may become excessively strong. To avoid this problem, in the case where N pieces of MS¹ peaks of the same mass-to-charge ratio (where N is an integer equal to or greater than two) have been individually and successfully identified, it is preferable to count the individual identification as 1/N in the determination of the empirical cumulative distribution function. In the example shown in FIG. 7, which shows that the identification was successful at the order numbers of 1, 2, 4, 5, 7 and 8, the solid line is an empirical cumulative distribution function for which the overlap of the mass-to-charge ratio was not taken into account. In this example, if the successfully identified MS¹ peaks ranked at the second and eighth places have the same mass-to-charge ratio, the overlap should be taken into account and each of the MS¹ peaks ranked at the second and eighth places should be counted as ½. As a result, the empirical cumulative distribution function will be modified as shown by the chain line in FIG. 7.

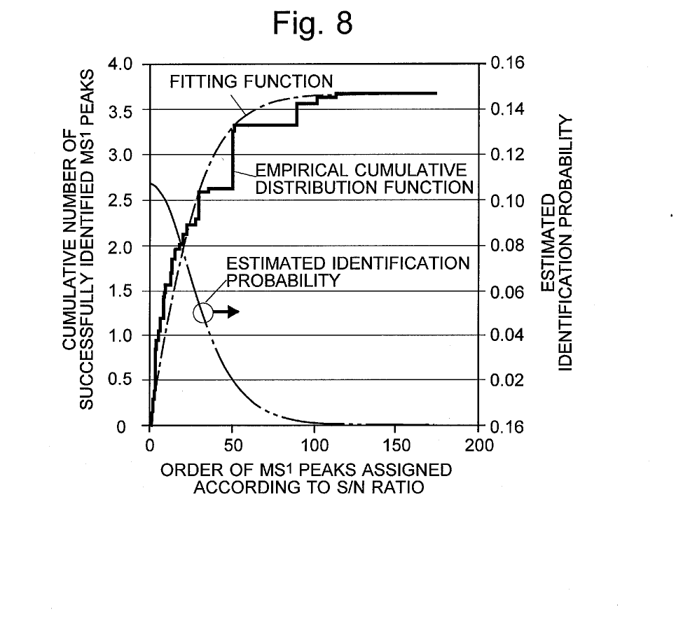

For the distribution of successfully or unsuccessfully identified MS¹ peaks shown in FIG. 6, if an empirical cumulative distribution function is determined with the overlap of the mass-to-charge ratio taken into account in the previously described manner, a staircase-like profile as shown in FIG. 8 is obtained. This profile shows that the larger the order number is (i.e. the lower the S/N ratio of the MS¹ peak is), the smaller the number of successfully identified MS¹ peaks becomes, causing the cumulative number of successful identifications to plateau (reach a saturation level).

[Step S15] Creation of Identification Probability Estimation Model and Calculation of Parameters

A fitting operation using an analytical function is performed on the staircase-like profile obtained in Step S14 to determine a smooth curve representing the relationship between the cumulative number of MS¹ peaks as counted in order of S/N ratio and that of successful identifications. In the present example, a hyperbolic function expressed by the following equation was used as the fitting function:

N^{(ident)}tan h(m/N^{(all)}σ) (5),

where m is the number of MS¹ peaks ranked higher than a certain level, and N^{(all)} and N^{(ident)} are the total number of MS¹ peaks and the number of successfully identified MS¹ peaks, respectively. The parameter σ determines the rate of rise of the fitting function, the value of which is calculated so that the function will fit the previously determined staircase-like profile. The chain line in FIG. 8 shows the curve that has been fitted to the staircase-like profile. This curve of the fitting function is the identification probability estimation model, and σ is the parameter that specifies this model.

Thus, the parameter σ, which determines the identification probability estimation model, can be calculated. This parameter σ is stored in a memory to be used for an estimation of the identification probability (Step S16).

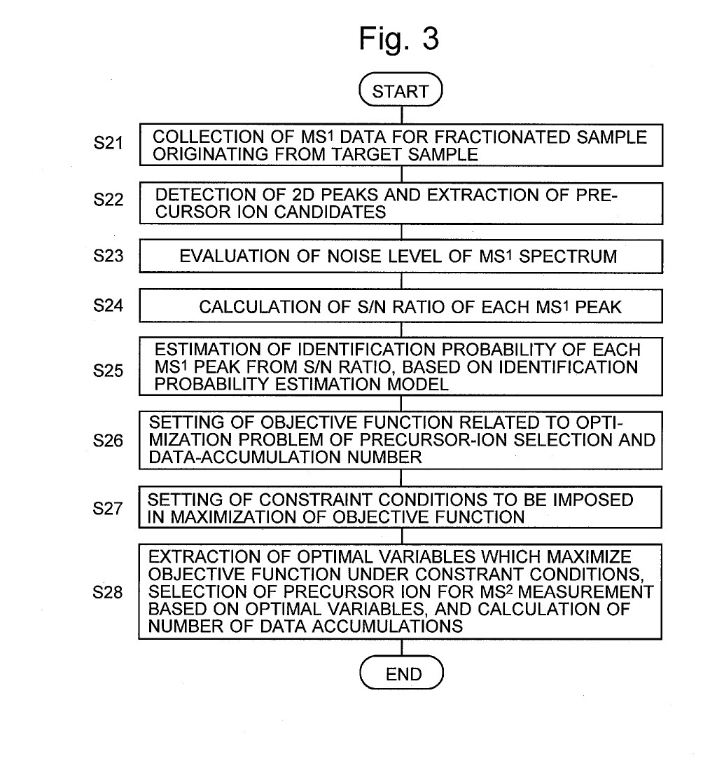

Under the condition that the aforementioned parameter of the identification probability estimation model is prepared in advance, an MS¹ peak suitable as a precursor ion is selected and an optimal MS² measurement sequence is determined, based on MS¹ spectra obtained by an MS¹ measurement of a plurality of fractionated samples obtained by separating and fractionating a target sample using a liquid chromatograph. The steps of this process are hereinafter described with reference to the flowchart shown in FIG. 3.

[Step S21] Collection of MS¹ Measurement Data Originating From Target Sample

Initially, an MS¹ measurement is performed for each of a number of fractionated samples prepared from a target sample, to collect MS¹ spectrum data. The obtained MS¹ spectra of the fractionated samples are aligned in order of retention time to construct a three-dimensional MS¹ spectrum.

[Step S22] Detection of 2D Peaks and Extraction of Precursor Ion Candidates

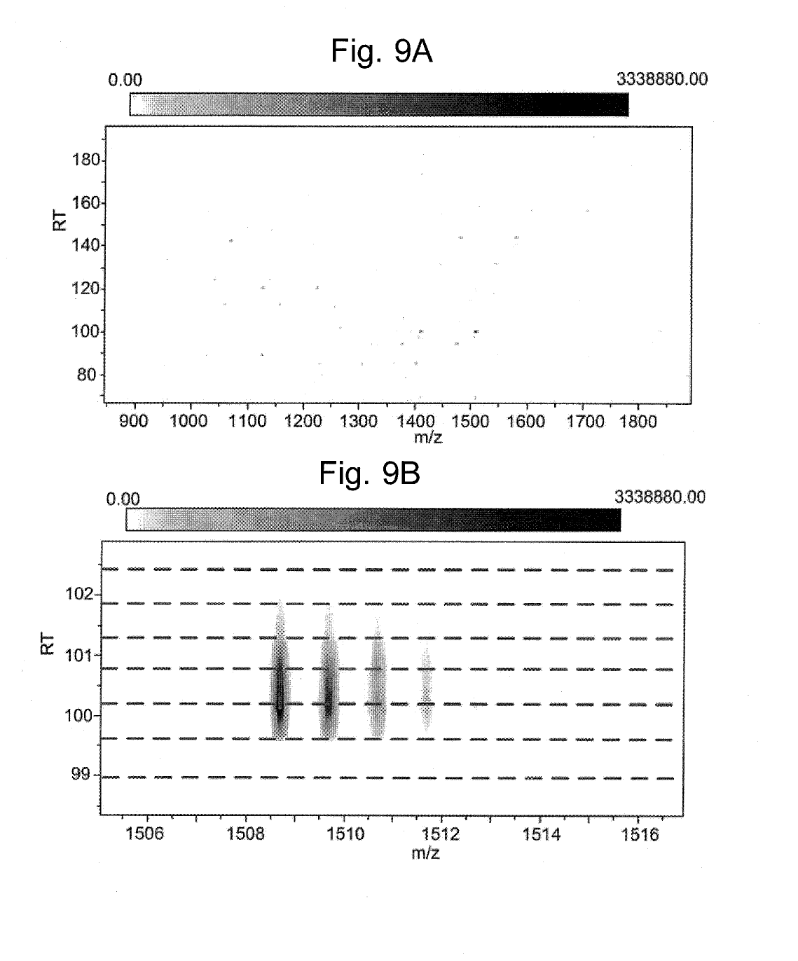

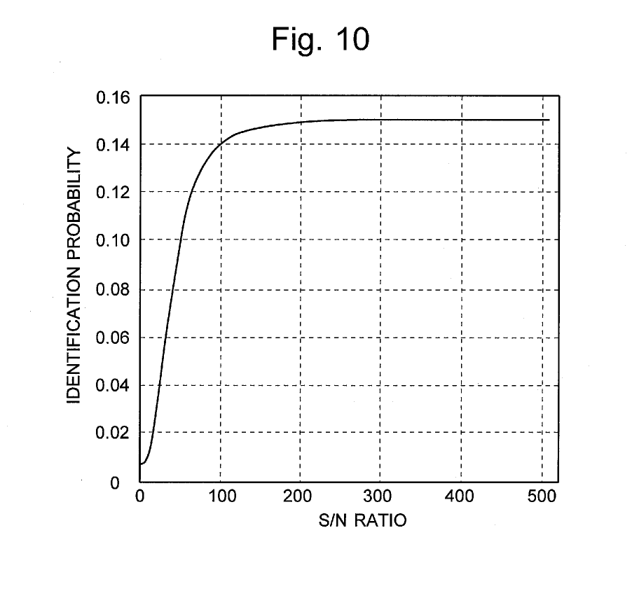

If the MS¹ spectra obtained for the respective fractionated samples are displayed in order of fractionating time, a heat map in which the signal intensity is represented with a gray scale (or colors) on a two-dimensional plane of mass-to-charge ratio m/z and retention time is obtained as shown in FIG. 9A. On this heat map, a two-dimensional peak detection is performed to extract MS¹ peaks. The peaks thereby detected are called the 2D peaks in the present description. In FIG. 9A, one point corresponds to one 2D peak.

Let the detected 2D peaks denoted by Pₖ^{(2D)} ((k=1, 2, . . . K). Each 2D peak corresponds to one component (substance) contained in the sample, while it is often the case that one component is observed not only at the fractionated sample in which the top of the 2D peak is located but also at a plurality of fractionated samples adjacent to that sample. FIG. 9B is an enlargement of a portion of FIG. 9A. The horizontally extending broken lines in FIG. 9B represent the division of the fractionations. This chart demonstrates that each 2D peak which corresponds to one dot in FIG. 9A is actually spread in the vertical direction over a plurality of fractionations. In such a case, an MS¹ peak originating from the same component and having the same mass-to-charge ratio will be observed at a plurality of successively fractionated samples. Accordingly, each 2D peak Pₖ^{(2D)} can be regarded as a set of one or more MS¹ peaks having the same mass-to-charge ratio.

Now, let P_{wj} (j=1, 2, . . . , K) represent each MS¹ peak included in any of the 2D peaks (regardless of which 2D peak includes the MS¹ peak in question) among a plurality of MS¹ peaks detected in a fractionated sample with serial number w which is assigned to each fractionated sample in order of time. For example, P₁₁ represents the first MS¹ peak (j=1) among a plurality of MS¹ peaks detected in the first fractionated sample (w=1). It should be noted that the value of j has no special meaning; for example, it may represent serial numbers assigned to the peaks in ascending order of mass-to-charge ratio.

The sum set of P_{wj} corresponds to the entire group of the MS¹ peaks included in any of the 2D peaks. Therefore, the following equation holds true:

∪_{w}{P_{wj}|∃jP_{wj}εPₖ^{(2D)}}=Pₖ^{(2D)} (6)

where ∪_{w} means union of sets respect to w.

With the thus extracted MS¹ peaks P_{wj} as the candidates of the precursor ion for an MS² measurement, a selection of suitable precursor ions and an optimization of the number of data accumulations are performed in the following steps:

[Step S23] Evaluation of Noise Level of MS¹ Spectrum

The noise level of each of the MS¹ spectra in each of the fractionated samples is evaluated by performing the same process as Step S12 (S121-S123).

[Step S24] Calculation of S/N Ratio of Each MS¹ Peak

For each MS¹ peak P_{wj} extracted in Step S22, an S/N ratio is calculated from the intensity of that peak and the noise level calculated in Step S23 for the fractionated sample in which that peak has been found.

[Step S25] Estimation of Identification Probability from S/N Ratio Based on Identification Probability Estimation Model

When the inclination of the fitting function given by equation (5) is one, it means that the identification will be successful with a probability of 100%, and when the inclination is 0.5, the probability is 50%. Accordingly, by the following equation (7), which is a derivative of the fitting function, the probability of successful identification for a given MS¹ peak can be estimated from its order number m:

(N^{(ident)}/N^{(all)}σ)sech²(m/N^{(all)}σ) (7)

The estimated identification probability expressed by the differential function of equation (7) is also shown in FIG. 8 (the scale on the right side in FIG. 8) in an overlapped form.

Converting the order numbers on the horizontal axis in FIG. 8 into the corresponding S/N ratios yields a function p₁(r) for obtaining an estimate of the identification probability for a given S/N ratio, where r is the S/N ratio of an MS¹ peak. Accordingly, for an MS¹ peak Pⱼ with an S/N ratio of r_{wj}, the identification probability is estimated to be p₁(r_{wj}). This value p₁(r_{wj}) indicates an estimated probability with which the identification will be successful if the MS² measurement is performed with a normal number of data accumulations, i.e. under the same conditions as used when the data used for creating the identification probability estimation model were obtained. If the number of times of the MS² measurement to be performed for the same MS¹ peak (i.e. the number of data accumulations) is increased n-fold, the S/N ratio of the MS² spectrum theoretically increases to a √n-fold value and the identification probability is also expected to improve with this increase in the S/N ratio. Accordingly, in the present embodiment, it is assumed that, when the number of data accumulations is increased n-fold, the identification probability of an MS¹ peak increases to the level corresponding to an S/N ratio which equals √n times the S/N ratio of the MS¹ peak in question. That is to say, it is assumed that, when the number of data accumulations for the same MS¹ peak is increased n-fold, the estimate pₙ(r_{wj}) of the identification probability is given by be calculated by the following equation:

pₙ(r_{wj})=p₁(√(n)r_{wj}) (8)

For ease of explanation, it is assumed that the normal number of data accumulations which was used when the data used for creating the identification probability estimation model were obtained is one (i.e. no accumulation), and that the n-fold accumulation means accumulating data n times. In this case, if the MS² measurement of the MS¹ peak P_{wj} is performed n times, the identification probability p_{wj}⁽ⁿ⁾ is given by the following equation:

pₙ(r_{wj})=p₁(√(n)r_{wj}) (9)

The actual number of data accumulations can be restored by multiplication with the normal number of data accumulation.

[Step S26] Setting of Objective Function Related to Optimization Problem of Precursor Ion Selection of and Data Accumulation Number

In this step, the optimization problem of the precursor ion selection and the data accumulation number for maximizing the expected value of the identification probability of a large number of substances is defined as the maximization of the sum of the identification probabilities p_{wj}⁽ⁿ⁾ estimated for the MS¹ peaks P_{wj} to be subjected to the MS² measurement. This problem is reduced to a 0-1 integer programming problem, which is one type of the linear programming problem, and is formulated as follows:

That is to say, a 0-1 variable x_{wj}⁽ⁿ⁾ which takes two values for the number of times of the MS² measurement performed for an MS¹ peak P_{wj} is defined as follows:

x_{wj}⁽ⁿ⁾=1: The MS² measurement with n times of data accumulations is performed for the MS¹ peak P_{wj}.

x_{wj}⁽ⁿ⁾=0: The other cases.

According to this definition, if x_{wj}⁽ⁿ⁾=0 for any value of n, it means that no MS² measurement is performed for the MS¹ peak P_{wj}. If x_{wj}⁽¹⁾=1 while x_{wj}⁽ⁿ⁾=0 for any value of n other than n=1, it means that the MS² measurement is performed only one time for the MS¹ peak P_{wj}, i.e. no data accumulation is performed. Due to a constraint expressed by equation (10) which will be mentioned later, it is ensured that, for each combination of w and j, there is no more than one value of n which satisfies x_{wj}⁽ⁿ⁾=1; for any other value of n, x_{wj}⁽ⁿ⁾=0.

Using the 0-1 variables x_{wj}⁽ⁿ⁾, the sum of the identification probabilities to be maximized can be expressed as follows:

f(x_{wj}⁽ⁿ⁾)=Σp_{wj}⁽ⁿ⁾×x_{wj}⁽ⁿ⁾ (10)

where Σ is the sum over all possible values of w, j and n. That is to say, equation (10) means the sum of the identification probabilities estimated for all the MS¹ peaks selected as the candidates of the precursor ions from all the fractionated samples being studied, while changing the value of n (data accumulation number) over a range from 1 to a preset value. The function f in equation (10) is used as the objective function to be maximized. The identification probabilities p_{wj}⁽ⁿ⁾ have known values which can be derived from the identification probability estimation model and the S/N ratios of the MS¹ peaks.

[Step S27] Setting of Constraint Conditions to be Imposed in Maximization of Objective Function

In the maximization of the objective function f, the following constraint conditions are set:

(A) If a MALDI ionization mass spectrometer is used, the sample will be gradually consumed every time a measurement is performed. Given such a depletion of the sample due to the repetition of the measurement, there should be an upper limit of the number of times of the measurement that can be performed for one fractionated sample, i.e. the number of data accumulations. Accordingly, the upper limit of the number of data accumulations for one fractionated sample w is set as U_{w}.

(B) Due to limitations of the measurement time or other factors, there should be an upper limit of the total number of data accumulations over the entire group of the fractionated samples being analyzed. The upper limit of the total number of data accumulations is set as U^{(Total)}.

(C) In addition to the aforementioned conditions, the following two conditions are also imposed:
The number of data accumulations is uniquely selected for each MS¹ peak P_{wj} (i.e. parameter n is not simultaneously given two or more values).
In the case where MS¹ peaks having the same mass-to-charge ratio exist in a plurality of successively obtained fractionated samples, only an MS¹ peak in one of those fractionated samples should be subjected to an MS² measurement.

The constraint conditions (A) through (C) can be represented by the following inequalities (11)-(13), respectively:

Σn×x_{wj}⁽ⁿ⁾≦U_{w} (11)

Inequality (11) should hold true for any value of w. Σ is the sum over all possible values of j and n.

Σn×x_{wj}⁽ⁿ⁾≦U^{(Total)} (12)

In inequality (12), Σ is the sum over all possible values of w, j and n.

Σx_{wj}⁽ⁿ⁾≦1 (13)

Inequality (13) should hold true for any value of k (i.e. for any of the detected 2D peaks Pₖ^{(2D)}). Σ is the sum over all possible values of w, j and n, except that the summation for w and j on the left side of inequality (13) is performed within the range of a specific 2D peak Pₖ^{(2D)} in which the MS¹ peak P_{wj} is present.

[Step S28] Calculation of Optimal Variables for Maximizing Objective Function Under Constraint Conditions, and Selection of Precursor Ion from Variables and Determination of Data Accumulation Number

The problem of finding the set of 0-1 variables x_{wj}⁽ⁿ⁾ which maximize the objective function expressed by equation (10) under the constraint conditions of inequalities (11)-(13) is generally called a 0-1 integer programming problem. There are various methods for solving 0-1 integer programming problems. Any of those methods is commonly known and hence will not be explained in the present description. In any case, an optimal set of 0-1 variables x_{wj}⁽ⁿ⁾ is obtained as a result of searching for the 0-1 variables that maximize equations (10). From the optimal set of variables thus found, all combinations of w, j and n which satisfy x_{wj}⁽ⁿ⁾=1 are extracted. Each MS¹ peak P_{wj} represented by an extracted pair of w and j corresponds to a precursor ion to be selected, and the value of n combined with this pair of w and j indicates the optimal number of data accumulations for that precursor ion. Thus, an optimal selection of the precursor ions and an optimization of the data accumulation number which lead to an overall improvement in the identification probability of a number of substances can be realized.

After the MS¹ peaks to be used as the precursor ions for the MS² measurement are thus selected, a measurement for the fractionated samples from which the MS¹ peaks can be obtained is performed in such a manner that an MS² measurement with one of the MS¹ peaks as the target is performed the specified number of times.

In general, an MS¹ peak with a low S/N ratio is more easily affected by a depletion of the sample than an MS¹ peak with a high S/N ratio. Therefore, when a plurality of MS¹ peaks in the same fractionated sample are selected as precursor ions, it is preferable to give a higher level of priority to an MS¹ peak with a low S/N ratio than an MS¹ peak with a high S/N ratio in the MS² measurement. This method improves the probability of successfully identifying a larger number of substances.

The previously described calculation for selecting optimal MS² precursor ions and optimizing the number of data accumulations is performed before the MS² measurement is actually carried out. The calculated result is no more than an expectation based on a known identification probability estimation model. Although the estimation of the identification probability is highly reliable, the optimization of the selection of the precursor ion and the data accumulation number based on the estimated result is not absolutely correct. Accordingly, it is preferable to perform, at an appropriate stage in the course of the MS² measurement, a process of checking the identification result using the MS² measurement result obtained up to that point in time and optimizing the subsequent measurement based on the check result.

In the previous description, the identification probability is calculated on the assumption that performing the data accumulation n times increases S/N ratios to √n times the original values. It is also possible to create an identification probability model for n-time data accumulation by conducting an MS² measurement with the data accumulation performed n times using a sample for model creation, performing an identification process using the measurement result, and deriving a fitting curve from the identification result according to Steps S11-S15 in FIG. 2. In this case, estimation of the identification probability for n-time data accumulation as expressed by equations (7) and (8) is unnecessary, since the identification probability for n-time data accumulation can be directly calculated from the identification probability model created for n-time data accumulation.

Thus, by the substance identification method according to the present invention, the number of data accumulations for the same MS¹ peak can be determined before the actual execution of the MS² measurements so as to maximize or nearly maximize the number of substances to be identified, by determining parameters of an identification probability estimation model in advance of the measurement of a target sample and performing simple computations and processes using that identification probability estimation model. The substance identification can be very efficiently performed by conducting MS² measurements using the precursor ions selected according to the determined MS² measurement sequence, and performing the substance identification process using the measured results.

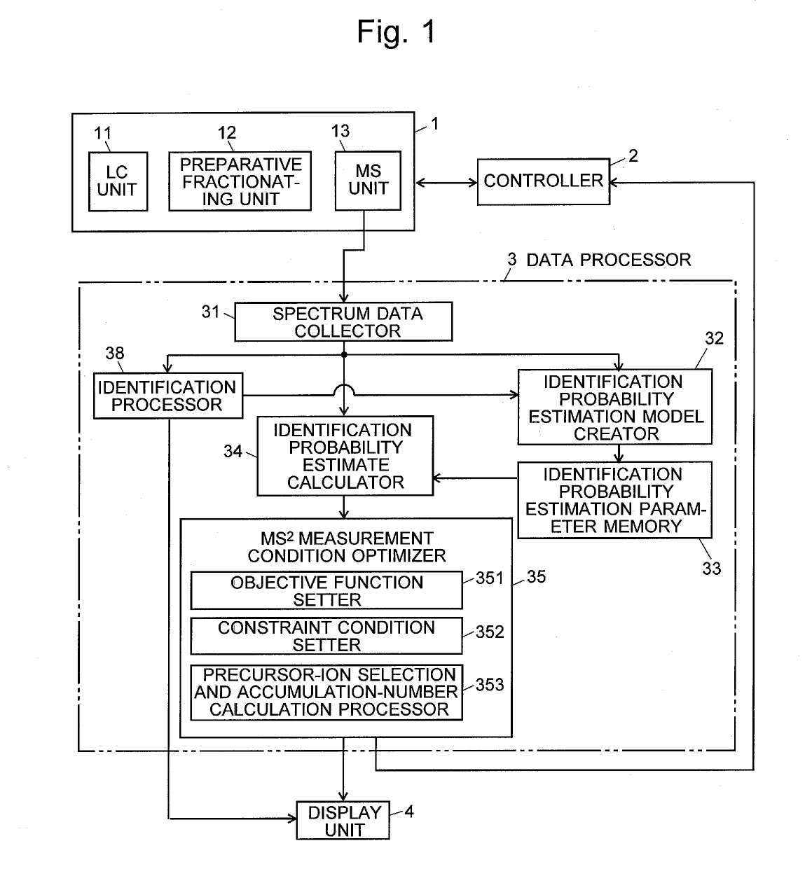

One embodiment of the mass spectrometer for carrying out the previously described substance identification method is hereinafter described by means of FIG. 1. FIG. 1 is a schematic configuration diagram of the mass spectrometer according to the present embodiment.

In FIG. 1, an analyzer section 1 includes a liquid chromatograph (LC) unit 11 for separating various kinds of substances in a liquid sample according to their retention time, a preparative fractionating unit 12 for preparative-fractionating the sample containing the substances separated by the LC unit 11 to prepare a plurality of different fractionated samples, and a mass spectrometer (MS) unit 13 for selecting one of the fractionated samples and performing a mass spectrometry for the selected sample. Though not shown, the MS unit 13 is a MALDI-IT-TOFMS including a MALDI ion source, an ion trap (IT) and a time-of-flight mass spectrometer (TOFMS). This unit is capable of not only an MS¹ measurement but also an MSⁿ measurement in which the selection of a precursor ion and the operation of collision induced dissociation are performed one or more times in the ion trap and then the mass spectrometry is performed in the TOFMS. In the case where MS¹ and MS² measurements only need to be performed (i.e. when there is no need to perform an MSⁿ measurement with n=3 or greater), a mass spectrometer with a simpler configuration may be used, such as a triple quadrupole mass spectrometer, in place of the combination of the ion trap and the TOFMS.

A controller 2 controls the operation of each unit of the analyzer section 1. Data obtained with the MS unit 13 of the analyzer section 1 are sent to and processed by a data processor 3. The result of this data processing is outputted, for example, on a display unit 4. The data processor 3 includes the following functional blocks: a spectrum data collector 31 for collecting measurement data, such as MS¹ or MSⁿ spectrum data; an identification probability estimation model creator 32 for performing the processes of Steps S12 through S16; an identification probability estimation parameter memory 33 for holding parameters obtained with the identification probability estimation model creator 32; an identification probability estimate calculator 34 for performing processes corresponding to Steps S22 through S25; an MS² measurement condition optimizer 35, which includes an objective function setter 351 for performing a process corresponding to Step S26, a constraint condition setter 352 for performing a process corresponding to Step S27, and a precursor-ion selection and accumulation-number calculation processor 353 for performing a process corresponding to Step S28; and an identification processor 38 for performing an identifying process according to a predetermined algorithm. The data processor 3 and the controller 2 may be realized by using a personal computer as hardware resources on which the aforementioned functional blocks are embodied by running a previously installed dedicated controlling and processing software program.

Prior to the comprehensive identification for a target sample, the analyzer section 1 under the control of the controller 2 performs MS¹ and MS² measurements for each fractionated sample obtained from a preparatory sample for the creation of an identification probability estimation model. The identification processor 38 performs an identifying process based on the collected data of MS¹ and MS² spectra. The identification probability estimation model creator 32 creates an identification probability estimation model based on the spectrum data and the result of identification. Then, one or more parameters for reproducing this identification probability estimation model are stored in the identification probability estimation parameter memory 33.

In the comprehensive identification of the target sample, the analyzer section 1 under the control of the controller 2 initially performs an MS¹ measurement for each fractionated sample obtained from the target sample, and the spectrum data collector 31 collects MS¹ spectrum data. For each set of MS¹ spectrum data obtained from one fractionated sample, the identification probability estimate calculator 34 calculates an estimated value of the identification probability for each of a plurality of MS¹ peaks selected as the candidates of the precursor ion, using the identification probability estimation model reproduced from the parameters read from the identification probability estimation parameter memory 33. Using the thus estimated values of the identification probability, the objective function setter 351 determines an objective function expressed by equation (10) so as to optimize the selection of precursor ions and the number of data accumulations for the MS² measurement. The constraint condition setter 352 determines inequalities (11)-(13) representing the constraint conditions. The precursor-ion selection and accumulation-number calculation processor 353 determines optimal variables which maximize the objective function. Based on the optimal variables, the processor 353 selects precursor ions suitable for identification and determines the number of data accumulations for each precursor ion. Based on the precursor ion and the number of data thus selected or determined, the processor 353 creates an optimal MS² measurement sequence.

The optimal MS² measurement sequence thus determined is sent to the controller 2. According to this MS² measurement sequence, the controller 2 automatically controls the analyzer section 1 to conduct an MS² measurement for each fractionated sample obtained from the target sample. The identification processor 38 performs the process of identifying the substances in the target sample based on the previously collected MS¹ spectrum data obtained for each fractionated sample originating from the target sample as well as the newly collected MS² spectrum data obtained for each MS¹ peak. The result of this identification is shown on the screen of the display unit 4. Thus, as compared to conventional systems, the mass spectrometer according to the present embodiment can identify a larger number of substances within a limited length of time or with a limited number of times of the measurement.

In the operation of the previously described embodiment, an MS² measurement according to an optimal MS² measurement sequence is automatically initiated after this sequence is determined. Alternatively, it is possible to temporarily show the optimal MSⁿ measurement sequence on the screen of the display unit 4 and defer the initiation of the MS² measurement and identification for the target sample until a user (analysis operator) enters a command for initiating the MS² measurement. Such a system allows users to appropriately modify the MS² measurement sequence according to their own judgments or experiences before executing the MS² measurement.

It should be noted that the previously described embodiment is a mere example of the present invention, and any change, modification or addition appropriately made within the spirit of the present invention will naturally fall within the scope of claims of the present patent application.

### REFERENCE SIGNS LIST

1 . . . Analyzer Section
11 . . . Liquid Chromatograph (LC) Unit
12 . . . Preparative Fractionating Unit
13 . . . Mass Spectrometer (MS) Unit
2 . . . Controller
3 . . . Data Processor
31 . . . Spectrum Data Collector
32 . . . Identification Probability Estimation Model Creator
33 . . . Identification Probability Estimation Parameter Memory
34 . . . Identification Probability Estimate Calculator
35 . . . MS² Measurement Condition Optimizer
351 . . . Objective Function Setter
352 . . . Constraint Condition Setter
353 . . . Precursor-Ion Selection and Accumulation-Number Calculation Processor
38 . . . Identification Processor
4 . . . Display Unit

1. A substance identification method for identifying a substance contained in each of a plurality of fractionated samples obtained by separating various substances contained in a sample according to a predetermined separation parameter and fractionating the sample, based on MSⁿ spectra obtained by performing an MSⁿ measurement (where n is an integer equal to or greater than two) for each of the plurality of fractionated samples, the method comprising:
a) an identification probability estimation model creation step, in which an identification probability estimation model is created using signal-to-noise ratios of MSⁿ⁻¹ peaks determined by MSⁿ⁻¹ measurements for a plurality of fractionated samples obtained from a predetermined sample and results of substance identification based on results of MSⁿ measurements performed using each of the MSⁿ⁻¹ peaks as a precursor ion, the identification probability estimation model showing a relationship between signal-to-noise ratios of a plurality of MSⁿ⁻¹ peaks originating from a same kind of sample and a cumulative number of peaks successfully identified through a series of MSⁿ measurements and identifications in which the MSⁿ⁻¹ peaks are sequentially selected as a precursor ion in order of signal-to-noise ratio, and in which identification probability estimation model information representing the identification probability estimation model is stored;
b) an identification probability estimation step, in which, after MSⁿ⁻¹ measurements for two or more fractionated samples successively obtained from a target sample to be identified are completed, a signal-to-noise ratio is calculated for each of a plurality of MSⁿ⁻¹ peaks which are candidates of the precursor ions for the MSⁿ measurements among the MSⁿ⁻¹ peaks found by the MSⁿ⁻¹ measurements, and in which an estimate of an identification probability of each of the MSⁿ⁻¹ peaks which are the candidates of the precursor ions is calculated from the signal-to-noise ratios of the MSⁿ⁻¹ peaks with reference to the identification probability estimation model created from the identification probability estimation model information; and
c) a measurement condition optimization step, in which, after an assumption is made about how much an identification probability will be improved by performing an MSⁿ measurement for the same MSⁿ⁻¹ peak a plurality of times and accumulating the results of the plurality of measurements, an objective function which maximizes a sum of the identification probabilities for various combinations of MSⁿ⁻¹ peaks and various number of data accumulations ranging from one to a preset number is formulated based on the identification probabilities respectively estimated in the identification probability estimation step for all the MSⁿ⁻¹ peaks which are precursor-ion candidates for a predetermined set of fractionated samples, and in which MSⁿ⁻¹ peaks to be subjected to the MSⁿ measurement are selected and the number of data accumulations for each of the selected MSⁿ⁻¹ peaks is determined by finding a solution which maximizes the objective function with constraint conditions imposed at least on a total number of executions of the MSⁿ measurement for the predetermined set of fractionated samples and on a total number of executions of the MSⁿ measurement for one fractionated sample.

2. The substance identification method according to claim 1, wherein it is assumed, in the measurement condition optimization step, that the identification probability achieved by increasing the number of data accumulations m-fold is equal to an identification probability at a √m-fold S/N ratio.

3. The substance identification method according to claim 1, wherein a measurement for the predetermined sample is performed before the measurement for the target sample, and based on a result of the former measurement, the identification probability estimation model is created in the identification probability estimation model creation step.

4. The substance identification method according to claim 1, wherein the measurement condition optimization step is performed in such a manner that the objective function and the constraint conditions are formulated as a linear programming problem, and a solution which maximizes the objective function is found.

5. The substance identification method according to claim 4, wherein the measurement condition optimization step is performed in such a manner that the objective function and the constraint conditions are formulated as a 0-1 integer programming problem in which each MS¹ peak with a variable equal to 1 and the number of data accumulations for this peak are found as a solution which maximizes the objective function.

6. The substance identification method according to claim 1, wherein, after the MSⁿ⁻¹ peaks to be subjected to the MSⁿ measurement are selected in the measurement condition optimization step, the MSⁿ measurement is performed in such a manner that a higher level of priority is given to an MSⁿ⁻¹ peak with a lower S/N ratio among the MSⁿ⁻¹ peaks.

7. The substance identification method according to claim 1, wherein a measurement sequence of the MSⁿ measurement is determined based on a result of a sequential process in the identification probability estimation step and the measurement condition optimization step before the MSⁿ measurement is actually performed.

8. The substance identification method according to claim 7, wherein a measurement sequence of the MSⁿ measurement is determined based on a result of a sequential process in the identification probability estimation step and the measurement condition optimization step before the MSⁿ measurement is actually performed, and after the MSⁿ measurement according to the measurement sequence is initiated, the measurement sequence is modified by using an identification result obtained in a course of the MSⁿ measurement.

9. A mass spectrometer capable of an MSⁿ measurement which performs substance identification using any of the substance identification methods according to claim 1, the mass spectrometer comprising a controller for carrying out an MSⁿ measurement with a precursor ion and a number of data accumulations automatically set according to an MSⁿ measurement sequence based on a result obtained in the measurement condition optimization step.

10. A substance identification method for identifying a substance contained in each of a plurality of fractionated samples obtained by separating various substances contained in a sample according to a predetermined separation parameter and fractionating the sample, based on MSⁿ spectra obtained by performing an MSⁿ measurement (where n is an integer equal to or greater than two) for each of the plurality of fractionated samples, the method comprising:
a) an identification probability estimation model creation step, in which an identification probability estimation model is created using signal-to-noise ratios of MSⁿ⁻¹ peaks determined by MSⁿ⁻¹ measurements for a plurality of fractionated samples obtained from a predetermined sample and results of substance identification based on results of MSⁿ measurements performed using each of the MSⁿ⁻¹ peaks as a precursor ion, the identification probability estimation model showing a relationship between signal-to-noise ratios of a plurality of MSⁿ⁻¹ peaks originating from a same kind of sample and a cumulative number of peaks successfully identified through a series of MSⁿ measurements and identifications in which the MSⁿ⁻¹ peaks are sequentially selected as a precursor ion in order of signal-to-noise ratio, and in which identification probability estimation model information representing the identification probability estimation model is stored, where
the identification probability estimation model for each number of data accumulations is created using results of substance identification obtained by performing an MSⁿ measurement for a same MSⁿ⁻¹ peak a plurality of times and accumulating results of the measurements while changing a number of times of the measurement, and identification probability estimation model information representing each of the identification probability estimation model is stored;
b) an identification probability estimation step, in which, after MSⁿ⁻¹ measurements for two or more fractionated samples successively obtained from a target sample to be identified are completed, a signal-to-noise ratio is calculated for each of a plurality of MSⁿ⁻¹ peaks which are candidates of the precursor ions for the MSⁿ measurements among the MSⁿ⁻¹ peaks found by the MSⁿ⁻¹ measurements, and in which an estimate of an identification probability of each of the MSⁿ⁻¹ peaks which are the candidates of the precursor ions is calculated for each number of data accumulations from the signal-to-noise ratios of the MSⁿ⁻¹ peaks with reference to the identification probability estimation model created from the identification probability estimation model information; and
c) a measurement condition optimization step, in which an objective function which maximizes a sum of the identification probabilities for various combinations of MSⁿ⁻¹ peaks and various number of data accumulations ranging from one to a preset number is formulated based on the identification probabilities respectively estimated in the identification probability estimation step for all the MSⁿ⁻¹ peaks which are precursor-ion candidates for a predetermined set of fractionated samples, and in which MSⁿ⁻¹ peaks to be subjected to the MSⁿ measurement are selected and the number of data accumulations for each of the selected MSⁿ⁻¹ peaks is determined by finding a solution which maximizes the objective function with constraint conditions imposed at least on a total number of executions of the MSⁿ measurement for the predetermined set of fractionated samples and on a total number of executions of the MSⁿ measurement for one fractionated sample.

11. The substance identification method according to claim 10, wherein a measurement for the predetermined sample is performed before the measurement for the target sample, and based on a result of the former measurement, the identification probability estimation model is created in the identification probability estimation model creation step.

12. The substance identification method according to claim 10, wherein the measurement condition optimization step is performed in such a manner that the objective function and the constraint conditions are formulated as a linear programming problem, and a solution which maximizes the objective function is found.

13. The substance identification method according to claim 12, wherein the measurement condition optimization step is performed in such a manner that the objective function and the constraint conditions are formulated as a 0-1 integer programming problem in which each MS¹ peak with a variable equal to 1 and the number of data accumulations for this peak are found as a solution which maximizes the objective function.

14. The substance identification method according to claim 10, wherein, after the MSⁿ⁻¹ peaks to be subjected to the MSⁿ measurement are selected in the measurement condition optimization step, the MSⁿ measurement is performed in such a manner that a higher level of priority is given to an MSⁿ⁻¹ peak with a lower S/N ratio among the MSⁿ⁻¹ peaks.

15. The substance identification method according to claim 10, wherein a measurement sequence of the MSⁿ measurement is determined based on a result of a sequential process in the identification probability estimation step and the measurement condition optimization step before the MSⁿ measurement is actually performed.

16. The substance identification method according to claim 15, wherein a measurement sequence of the MSⁿ measurement is determined based on a result of a sequential process in the identification probability estimation step and the measurement condition optimization step before the MSⁿ measurement is actually performed, and after the MSⁿ measurement according to the measurement sequence is initiated, the measurement sequence is modified by using an identification result obtained in a course of the MSⁿ measurement.

17. A mass spectrometer capable of an MSⁿ measurement which performs substance identification using any of the substance identification methods according to claim 10, the mass spectrometer comprising a controller for carrying out an MSⁿ measurement with a precursor ion and a number of data accumulations automatically set according to an MSⁿ measurement sequence based on a result obtained in the measurement condition optimization step.
